(19) United States
(12) Patent Application Publication
(10) Pub. No.: US 2019/0186135 A1
(43) Pub. Date: Jun. 20, 2019

(54) CONNECTOR SYSTEM FOR TRUSSES

(71) Applicant: TIFFIN SCENIC STUDIOS, INC., Tiffin, OH (US)

(72) Inventor: Brad E. Hossler, Tiffin, OH (US)

(21) Appl. No.: 16/223,803

(22) Filed: Dec. 18, 2018

Related U.S. Application Data
(60) Provisional application No. 62/599,897, filed on Dec. 18, 2017.

(51) Int. Cl. E04C 3/02; F16C 11/10; E04C 3/38; A63J 1/00

(52) U.S. Cl. CPC E04C 3/02; A63J 1/00; E04C 3/38; F16C 11/10

(57) ABSTRACT

A truss arch includes a plurality of trusses coupled together by connector systems. The trusses are adapted to support an appliance, such as a light, speaker, video display, or other device used during stage performances or events.

### PRIORITY CLAIM

This application claims priority under 35 U.S.C. § 119(e) to U.S. Provisional Application Ser. No. 62/599,897, filed Dec. 18, 2017, the disclosure of which is expressly incorporated by reference herein.

### FIELD OF THE DISCLOSURE

The present disclosure relates generally to stage equipment, and more specifically to trusses used to support appliances, such as lights, video boards, audio components, scenery, drapery, etc.

### BACKGROUND

Lights and other equipment used for events, such as concerts, plays, or other gatherings, may be held on trusses. The trusses may be transported to an event location and secured together to form scaffolding for positioning the equipment relative to a stage, for example. The size and weight of the equipment attached to these trusses presents design challenges to their positioning and operation.

### SUMMARY

The present application discloses one or more of the features recited in the appended claims and/or the following features which, alone or in any combination, may comprise patentable subject matter.

A truss arch in accordance with the present disclosure includes a plurality of trusses coupled together by connector systems. The trusses are adapted to support an appliance, such as a light, speaker, video display, or other device used during stage performances or events.

In illustrative embodiments, each connector system includes an expansion joint coupled between adjacent trusses along a first side and a pivot joint coupled along an opposite second side. The pivot joint allows the adjacent trusses to rotate relative to one another about a pivot axis extending through the pivot joint. The expansion joint is movable from a collapsed position where the trusses are substantially aligned and parallel with one another and an expanded position where the trusses are rotated about the pivot axis through the pivot joint and positioned at an angle relative to one another such that ends of the trusses are aligned along a curve.

In illustrative embodiments, each expansion joint includes first and second caps and first and second sets of links coupled between the first and second caps. Each cap is coupled to one of the trusses and facing the other cap on the other truss. The first set of links is coupled to the first cap, the second set of links are coupled to the second cap, and the first and second sets of links are coupled to one another. The links move between a relaxed-hanging position when the expansion joint is in the collapsed position and a tensioned-supporting position when the expansion joint is in the expanded position. The caps engage with one another when the expansion joint is in the collapsed position and are spaced apart from one another when the expansion joint is in the expanded position.

In illustrative embodiments, each link includes a mount hole and a plurality of adjustment holes positioned at various distances from the mount hole. The mount holes allow the links to be coupled with the trusses, and the adjustment holes allow the links to be coupled to one another. A pin extends through aligned sets of adjustment holes on the links to set a maximum angle for the trusses to rotate relative to one another. The angle is adjustable at the selection of a user by aligning different adjustment holes together and inserting the pin.

These and other features of the present disclosure will become more apparent from the following description of the illustrative embodiments.

### BRIEF DESCRIPTION OF THE DRAWINGS

FIG. 1 is an upper perspective view of one embodiment of a truss arch in accordance with the present disclosure showing that the truss arch includes trusses coupled together by an expandable connector system and that the trusses are positioned at an angle relative to one another such that ends of the trusses are aligned along a curve;

FIG. 2 is an exploded assembly view of one embodiment of an expandable connector system in accordance with the present disclosure showing that the expandable connector system includes an expansion joint attached between upper couplers of the trusses and a pivot joint coupled to lower couplers of the trusses;

FIG. 3 is a side perspective view of the expandable connector system of FIG. 2 showing the expansion joint in a collapsed position where caps of the expansion joint contact one another and links connecting the caps together are in a relaxed-hanging position and suggesting that the trusses are aligned with one another in a substantially straight position when the expansion joint is in the collapsed position;

FIG. 4 is a view similar to FIG. 3 showing the expansion joint in an expanded position where the caps of the expansion joint are spaced apart from one another and the links are in a tensioned-supporting position and suggesting that the trusses rotate relative to one another about a pivot axis (A) through the pivot joint into the arched position shown in FIG. 1 when the expansion joint is in the expanded position;

FIG. 5 is a top plan view of the expansion joint of FIG. 4 showing that pins connect the links and caps to the couplers of the trusses and connect the links to one another;

FIG. 6 is a side elevation view of the expansion joint of FIG. 4 showing that axes extending through the upper and lower couplers of the trusses are at an angle (a) relative to one another when the expansion joint is in the expanded position and suggesting that the axes are substantially parallel to one another when the expansion joint is in the collapsed position;

FIG. 7 is a side elevation view of one embodiment of a truss arch in accordance with the present disclosure showing that wires suspending the truss arch are at different heights relative to a horizon (H) and suggesting that the expandable connector systems coupled between the trusses allow the trusses to move into an arched position;

FIG. 8 is a top plan view of a truss string in accordance with the present disclosure showing that the truss string includes trusses coupled together by the pivot joint to allow the trusses to rotate laterally relative to one another such that the trusses are positioned at an angle (p);

FIG. 9 is an upper perspective view of another embodiment of a truss arch in accordance with the present disclosure;

FIG. 10 is an exploded assembly view of the truss arch of FIG. 9 showing that the truss arch includes trusses connected together by another embodiment of an expandable connector system in accordance with the present disclosure and that the expandable connector system includes an expansion joint attached between upper couplers of the trusses and a pivot joint coupled to lower couplers of the trusses;

FIG. 11 is a perspective view of the expansion joint of FIG. 10;

FIG. 12 is a perspective view of the pivot joint of FIG. 10;

FIG. 13 is an exploded assembly view of the expansion joint of FIG. 11 showing that the expansion joint includes caps and links connecting the caps together and suggesting that adjustment holes on the links allow the expansion joint to expand to different distances at the selection of a user to adjust an angle of the connected trusses relative to one another;

FIG. 14 is an exploded assembly view of the pivot joint of FIG. 12 showing that the pivot joint includes caps coupled together by a pin to allow pivoting of the caps relative to one another around the pin; and

FIG. 15 is a side elevation view of the truss arch of FIG. 9 showing that axes extending through the upper and lower couplers of the trusses are at an angle (a) relative to one another when the expansion joint is in the expanded position and suggesting that the axes are substantially parallel to one another when the expansion joint is in the collapsed position.

### DETAILED DESCRIPTION

For the purposes of promoting an understanding of the principles of the disclosure, reference will now be made to a number of illustrative embodiments illustrated in the drawings and specific language will be used to describe the same.

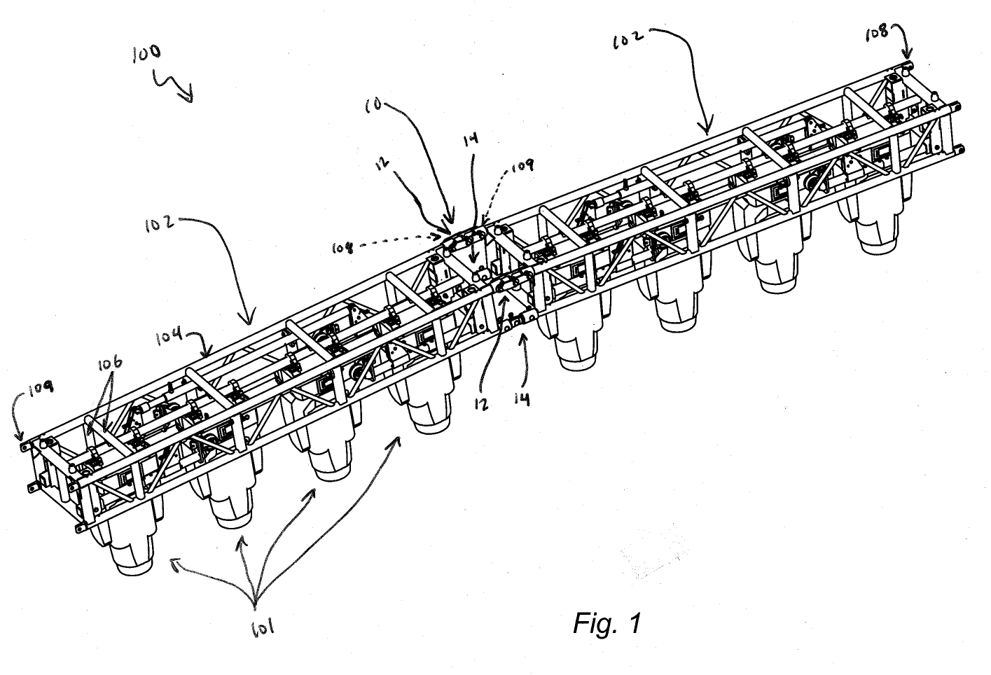

An illustrative truss arch 100 in accordance with the present disclosure is shown in FIG. 1. Truss arch 100 includes trusses 102 attached together by an expandable connector system 10 in accordance with the present disclosure. Each expandable connector system 10 includes an expansion joint 12 and a pivot joint 14 coupled along opposing sides of trusses 102. Expandable connector systems 10 allow trusses 102 to rotate relative to one another to form truss arch 100. In the illustrative embodiment, expansion joint 12 is coupled along an upper portion of trusses 102 and pivot joint 14 is coupled along a lower portion of trusses 102 such that the lower portions of trusses 102 rotate toward one another in forming truss arch 100. In other embodiments, the expansion joints 12 and pivot joints 14 can be positioned along other sides (such as left and right (lateral) sides) to allow for articulation of trusses 102 in different directions.

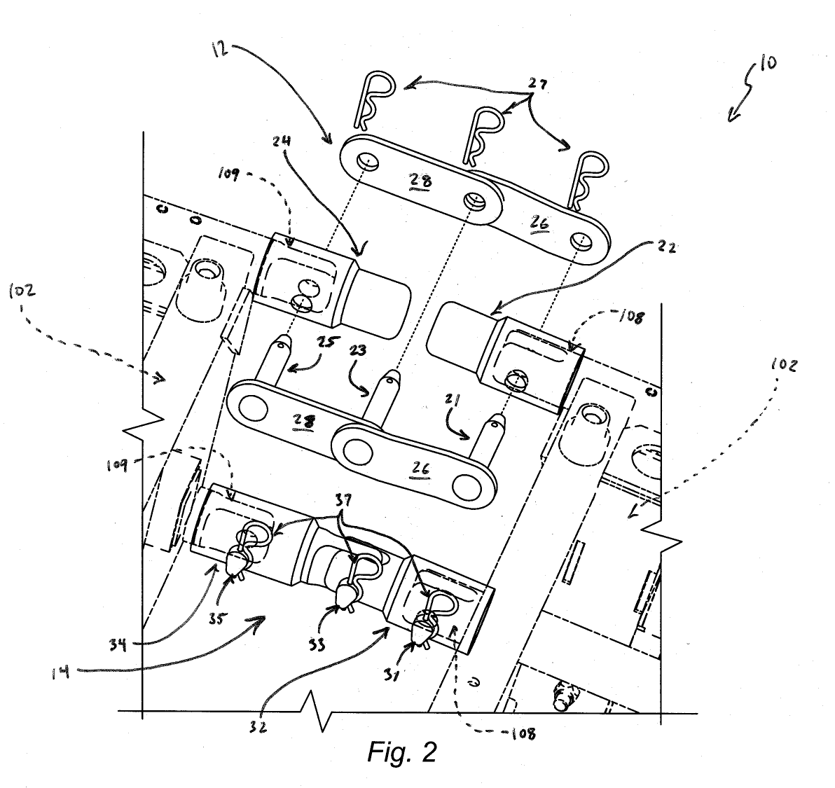

Each truss 102 includes beams 104 extending between opposing ends of truss 102 and a plurality of cross bars 106 coupled to beams 104 as shown in FIG. 1. Trusses 102 are configured to support appliances 101, such as lights, for use during an event or stage performance, for example. Couplers 108, 109 are attached to beams 104 at opposing ends of trusses 102. In the illustrative embodiment, couplers 108, 109 include a fork coupler 108 and an eye coupler 109 configured to engage with fork coupler 108 for connecting trusses 102 together into a string when expandable connector system 10 is not used. Expandable connector systems 10 are configured to attach onto couplers 108, 109, as suggested in FIG. 2, to allow formation of truss arch 100 without modification to the existing structure of trusses 102. In some embodiments, expandable connector systems 10 can be configured as a separate kit for use with other trusses in forming an arch.

Expansion joint 12 includes caps 22, 24 and links 26, 28 as shown in FIG. 2. Caps 22, 24 are configured to receive couplers 108, 109, respectively, in cavities of caps 22, 24 for attachment with couplers 108, 109. In the illustrative embodiment, a first set of links 26 is coupled to cap 22 by a pin 21 and a second set of links 28 is coupled to cap 24 by a pin 25. Pins 21, 25 also connect caps 22, 24, respectively, with couplers 108, 109. A pin 23 connects links 26 with links 28. Pins 21, 23, 25 allow links 26, 28 to rotate relative to caps 22, 24 and relative to one another. In some embodiments, more or less links 26, 28 can be used. Clips 27 engage with pins 21, 23, 25 to block removal of pins 21, 23, 25.

Pivot joint 14 includes caps 32, 34 connected together by a pin 33 as shown in FIG. 2. Caps 32, 34 are configured to receive couplers 108, 109, respectively, in cavities of caps 32, 34 for attachment with couplers 108, 109. Pins 31, 35 connect caps 32, 34, respectively, with couplers 108, 109. Clips 37 engage with pins 31, 33, 35 to block removal of pins 31, 33, 35.

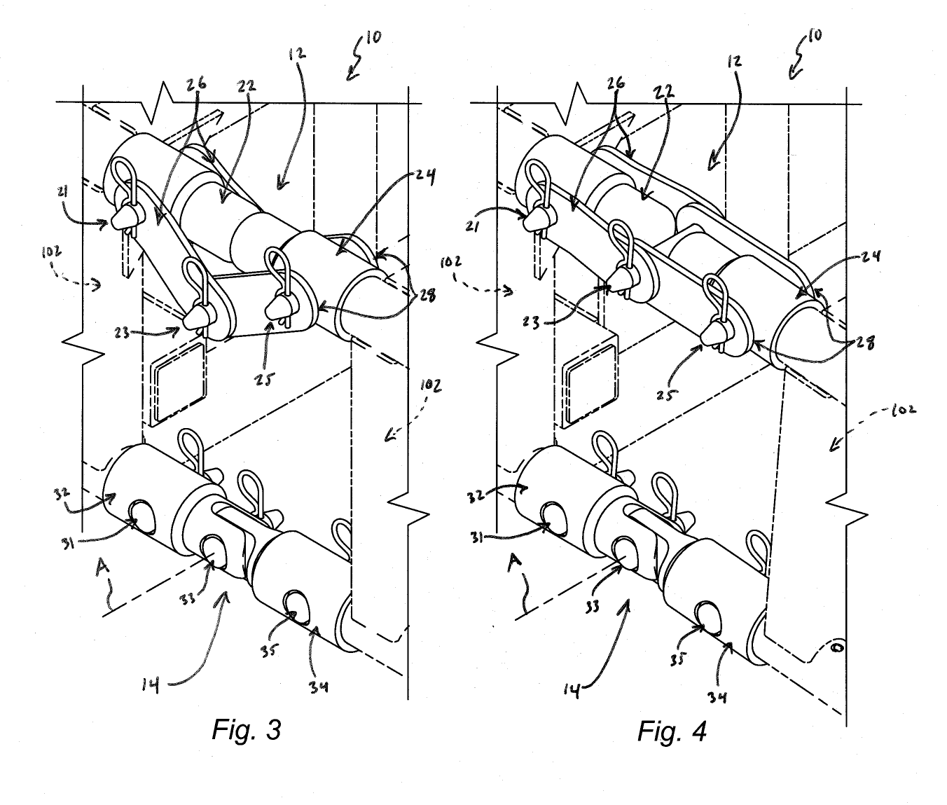

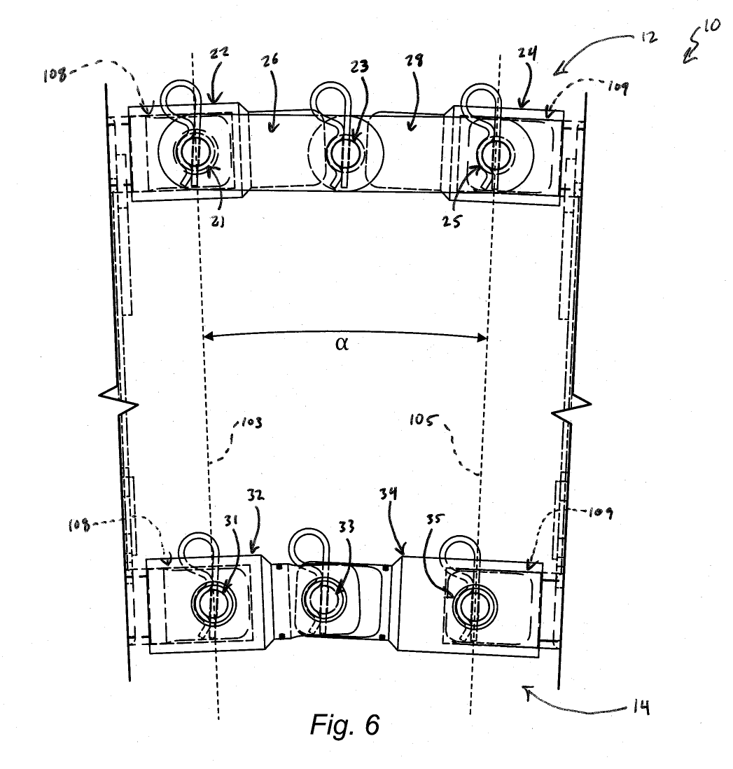

Expansion joint 12 is movable between a collapsed position and an expanded position as shown in FIGS. 3-6. In the collapsed position, caps 22, 24 are engaged with one another and links 26, 28 are in a relaxed-hanging position as shown in FIG. 3. In the relaxed-hanging position, pin 23 is offset from a line extending through pins 21, 25. Expansion joint 12 moves to the expanded position as trusses 102 rotate about a pivot axis A through pin 33 of pivot joint 14 as suggested in FIGS. 3 and 4. In the expanded position, caps 22, 24 are spaced apart from one another and links 26, 28 are in a tensioned-supporting position as shown in FIG. 4. In the tensioned-supporting position, pins 21, 23, 25 are substantially aligned along a line extending through pins 21, 25.

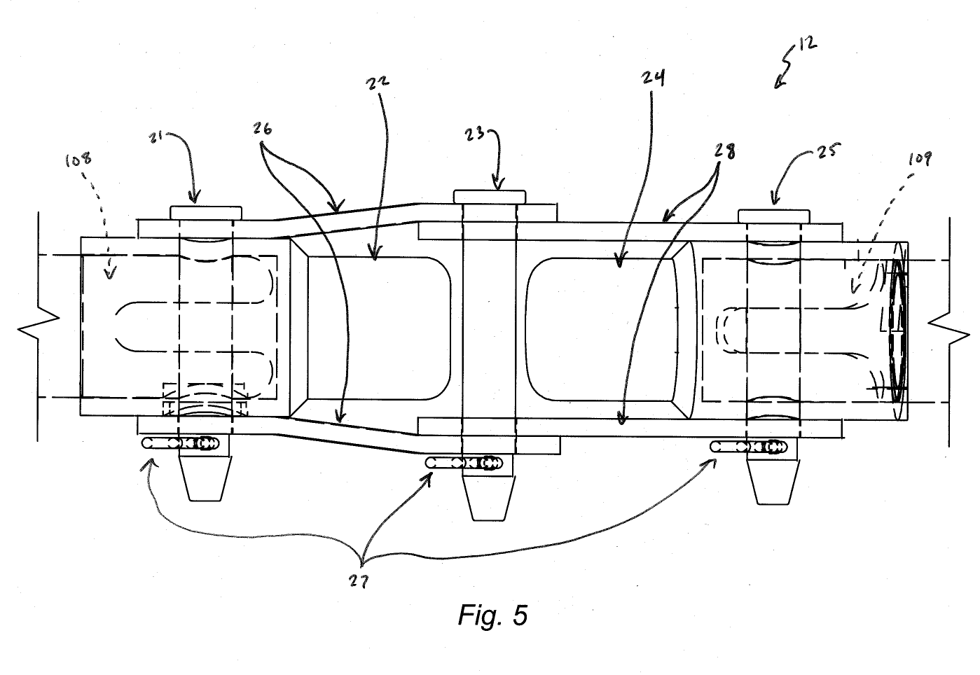

In the illustrative embodiment, links 26 are bent to be positioned laterally outward from links 28 as shown in FIG. 5. In the expanded position, a measurement axis 103 extending through pins 21, 31 and a measurement axis 105 extending through pins 25, 35 are at a predetermined angle α relative to one another. Expansion joint 12 is configured to block rotation of trusses 102 past angle α. Angle α is adjustable by adjusting a length of links 26, 28. In the collapsed position, axes 103, 105 are substantially parallel to one another such that trusses 102 are aligned in a substantially straight position relative to one another.

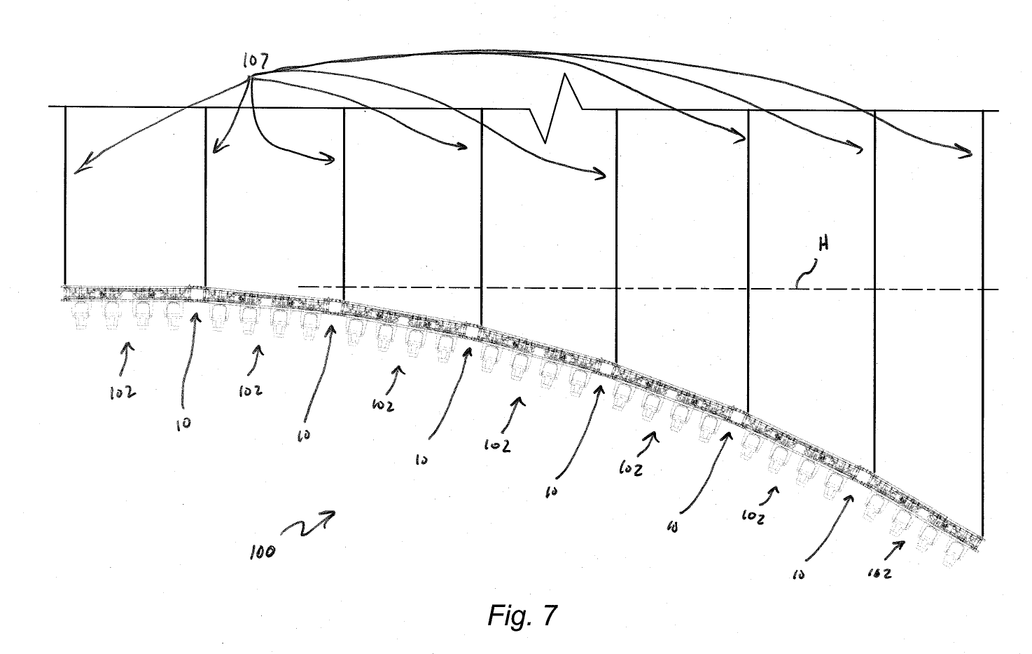

In one illustrative embodiment of a process for forming truss arch 100, trusses 102 are arranged adjacent to one another in a horizontal position and connected together by expandable connector systems 10. Trusses 102 are raised by wires 107 as shown in FIG. 7. In the illustrative embodiment, a relative length of wires 107 is adjusted compared to a horizon H such that trusses 102 rotate relative to one another and form truss arch 100. In the arched position, ends of trusses 102 are aligned along an arc. In some embodiments, pivot joints 14 are attached along a top portion of trusses 102, and expansion joints 12 are coupled along a lower portion of trusses 102, to allow an upward curving truss arch to be formed. In some embodiments, expandable connector systems 10 can allow trusses 102 to be aligned along various repeating and non-repeating patterns including arcs, waves, flats, angles, and other orientations, whether vertically, horizontally, positions in-between, or combinations thereof.

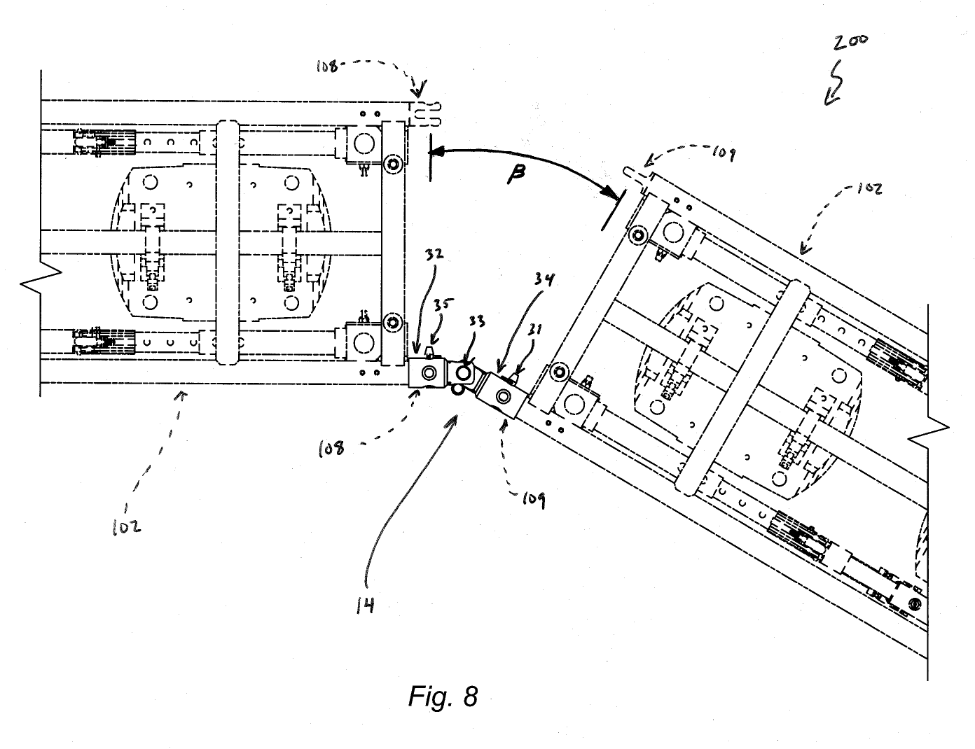

One illustrative embodiment of a truss string 200 in accordance with the present disclosure is shown in FIG. 8. Pivot joint 14 is connected along a lateral side of trusses 102 with pin 33 extending in a direction from upper couplers 108, 109 toward lower couplers 108, 109 to allow trusses 102 to rotate relative to one another at an angle β. Angle β is adjustable. In some embodiments, expansion joints 12 are coupled along the opposing lateral side of trusses 102 from pivot joints 14 to set a predetermined angle β and block rotation of trusses 102 past angle β.

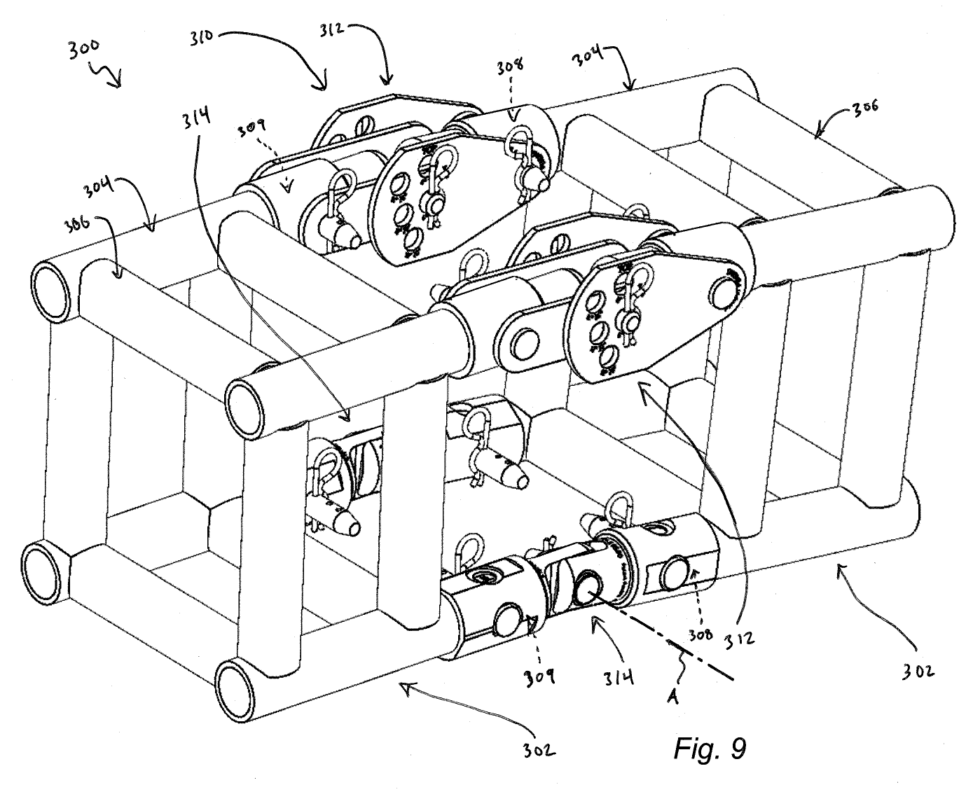

Another embodiment of a truss arch 300 in accordance with the present disclosure is shown in FIG. 9. Truss arch 300 includes trusses 302 (only a portion shown in FIG. 9) attached together by an expandable connector system 310 in accordance with the present disclosure. Each expandable connector system 310 includes an expansion joint 312 and a pivot joint 314 coupled along opposing sides of trusses 302. Expandable connector systems 310 allow trusses 302 to rotate relative to one another to form truss arch 300. In the illustrative embodiment, expansion joint 312 is coupled along an upper portion of trusses 302 and pivot joint 314 is coupled along a lower portion of trusses 302 such that the lower portions of trusses 302 rotate toward one another in forming truss arch 300. In other embodiments, the expansion joints 312 and pivot joints 314 can be positioned along other sides to allow for articulation of trusses 302 in different directions.

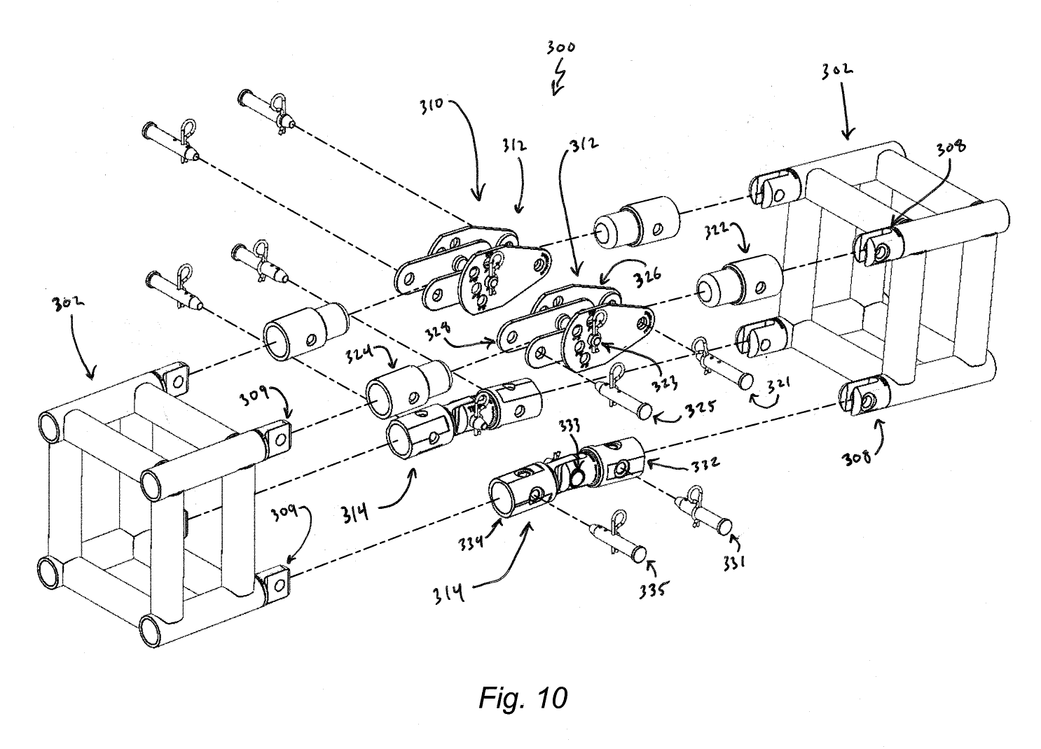

Each truss 302 includes beams 304 extending between opposing ends of truss 302 and a plurality of cross bars 306 coupled to beams 304 as shown in FIG. 9. Trusses 302 are similar to trusses 102 shown in FIGS. 1-8 and are configured to support appliances, such as lights, for use during an event or stage performance, for example. Couplers 308, 309 are attached to beams 304 at opposing ends of trusses 302. In the illustrative embodiment, couplers 308, 309 include a fork coupler 308 and an eye coupler 309 configured to engage with fork coupler 308 for connecting trusses 302 together into a string when expandable connector system 310 is not used. Expandable connector systems 310 are configured to attach onto couplers 308, 309, as suggested in FIG. 10, to allow formation of truss arch 300 without modification to the existing structure of trusses 302. In some embodiments, expandable connector systems 310 can be configured as a separate kit for use with other trusses in forming an arch.

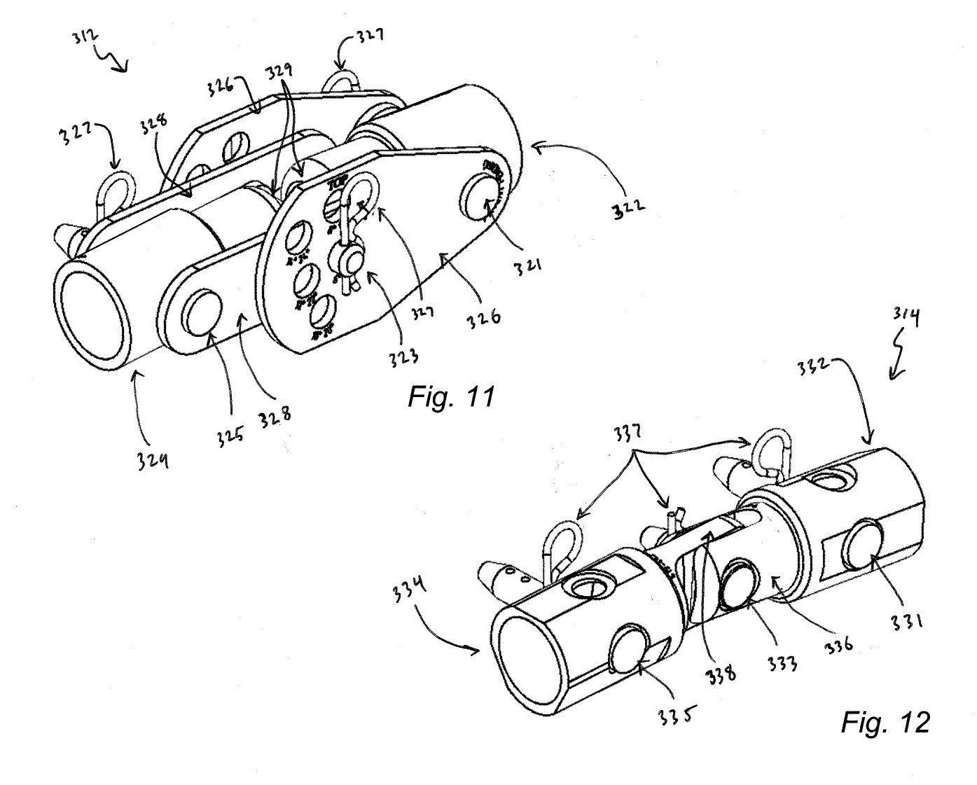

Expansion joint 312 includes caps 322, 324 and links 326, 328 as shown in FIGS. 10, 11, and 13. Caps 322, 324 are configured to receive couplers 308, 309, respectively, in cavities of caps 322, 324 for attachment with couplers 308, 309. Each cap 322, 324 is formed to define a contact area 329 configured to engage with contact area 329 of the other cap 322, 324 as further explained below. In the illustrative embodiment, a first set of links 326 is coupled to cap 322 by a pin 321 and a second set of links 328 is coupled to cap 324 by a pin 325. Pins 321, 325 also connect caps 322, 324, respectively, with couplers 308, 309. A pin 323 connects links 326 with links 328. Pins 321, 323, 325 allow links 326, 328 to rotate relative to caps 322, 324 and relative to one another. In some embodiments, more or less links 326, 328 can be used. Clips 327 engage with pins 321, 323, 325 to block removal of pins 321, 323, 325.

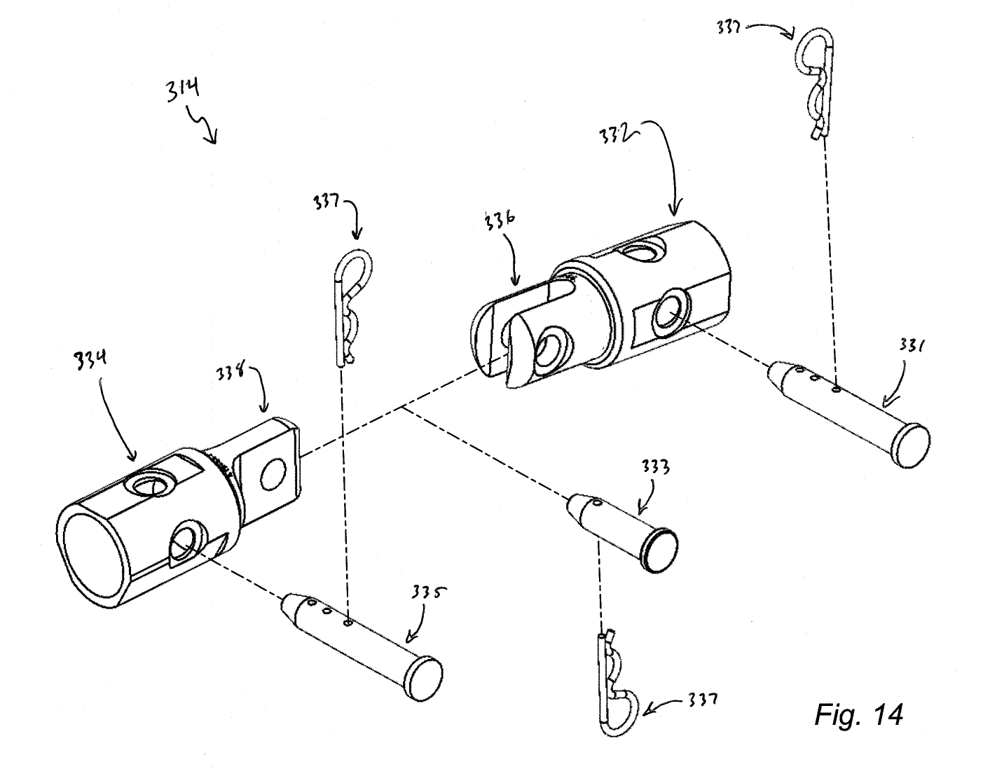

Pivot joint 314 includes caps 332, 334 connected together by a pin 333 as shown in FIGS. 10, 12, and 14. Pin 333 extends through flanges 336, 338 of caps 332, 334, respectively. In the illustrative embodiment, flanges 336, 338 are configured as a fork 336 and an eye 338. Caps 332, 334 are configured to receive couplers 308, 309, respectively, in cavities of caps 332, 334 for attachment with couplers 308, 309. Pins 331, 335 connect caps 332, 334, respectively, with couplers 308, 309. Clips 337 engage with pins 331, 333, 335 to block removal of pins 331, 333, 335.

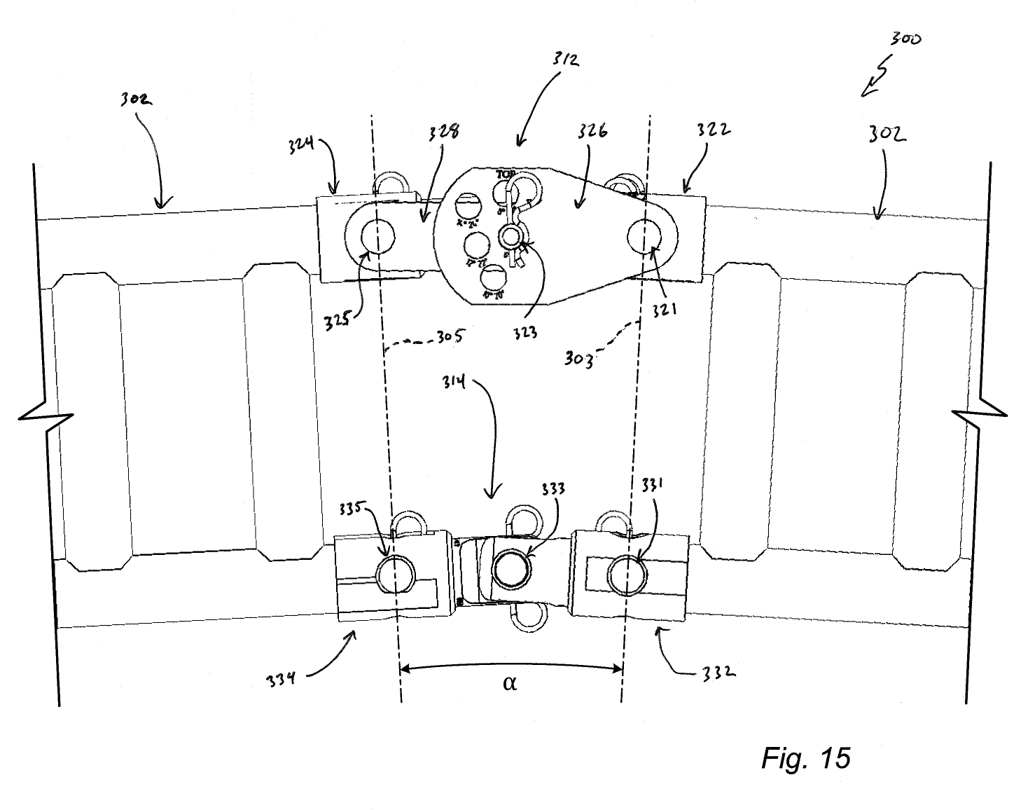

Expansion joint 312 is movable between a collapsed position and an expanded position similar to expansion joint 12 shown in FIGS. 3 and 4. In the collapsed position, contact areas 329 of caps 322, 324 are engaged with one another and links 326, 328 are in a relaxed-hanging position. In the relaxed-hanging position, pin 323 is offset from a line extending through pins 321, 325. In the collapsed position, trusses 302 are substantially aligned and parallel with one another. Expansion joint 312 moves to the expanded position as trusses 302 rotate about a pivot axis A through pin 333 of pivot joint 314 as suggested in FIG. 9. In the expanded position, caps 322, 324 are spaced apart from one another and links 326, 328 are in a tensioned-supporting position. In the tensioned-supporting position, pins 321, 323, 325 are substantially aligned along a line extending through pins 321, 325. In the expanded position, a measurement axis 303 extending through pins 321, 331 and a measurement axis 305 extending through pins 325, 335 are at a predetermined angle α relative to one another as shown in FIG. 15. Expansion joint 312 is configured to block rotation of trusses 302 past angle α. In the collapsed position, axes 303, 305 are substantially parallel to one another such that trusses 302 are substantially aligned and parallel relative to one another. Angle α is adjustable as further detailed below.

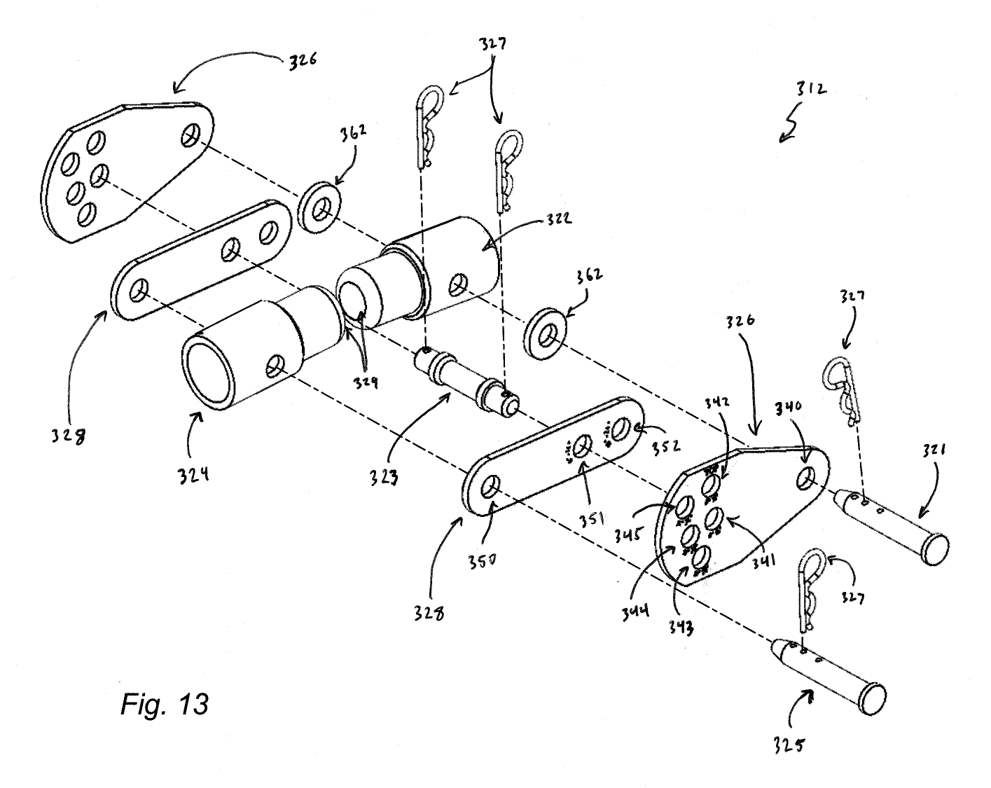

In the illustrative embodiment, each link 326 of expansion joint 312 includes a mount hole 340 and a plurality of adjustment holes 341-345 as shown in FIG. 13. Each adjustment hole 341-345 is positioned at a different distance from mount hole 340 to adjust the relative maximum angle α between trusses 302 in forming truss arch 300. Each link 328 includes a mount hole 350 and a plurality of adjustment holes 351, 352. Each adjustment hole 351, 352 is positioned at a different distance from mount hole 350 to adjust the relative maximum angle α between trusses 302 in forming truss arch 300. More or less adjustment holes 341-345, 351, 352 can be used.

Pin 321 extends mount holes 340 of links 326 and through cap 322 as shown in FIG. 13. In some embodiments, spacers 362 are positioned between cap 322 and links 326. Pin 325 extends mount holes 350 of links 328 and through cap 324. A user of expandable connector system 310 determines a desired maximum angle between trusses 302 and inserts pin 323 into the corresponding adjustment holes 341-345, 351, 352. This likewise adjusts a maximum amount of expansion for expansion joint 312 (i.e., distance between caps 322, 324). In the illustrative embodiment, adjustment hole 351 allows for maximum angles α in a range of about 6 degrees to about 14 degrees while adjustment hole 352 allows for maximum angles α in a range of about 16 degrees to about 24 degrees, though other ranges are contemplated by this disclosure. Inserting pin 323 through adjustment holes 341, 351 sets a maximum angle α of about 6 degrees. Inserting pin 323 through adjustment holes 342, 351 sets a maximum angle α of about 8 degrees. Inserting pin 323 through adjustment holes 343, 351 sets a maximum angle α of about 10 degrees. Inserting pin 323 through adjustment holes 344, 351 sets a maximum angle α of about 12 degrees. Inserting pin 323 through adjustment holes 345, 351 sets a maximum angle α of about 14 degrees. Inserting pin 323 through adjustment holes 341, 352 sets a maximum angle α of about 16 degrees. Inserting pin 323 through adjustment holes 342, 352 sets a maximum angle α of about 18 degrees. Inserting pin 323 through adjustment holes 343, 352 sets a maximum angle α of about 20 degrees. Inserting pin 323 through adjustment holes 344, 352 sets a maximum angle α of about 22 degrees. Inserting pin 323 through adjustment holes 345, 352 sets a maximum angle α of about 24 degrees.

In one illustrative embodiment of a process for forming truss arch 300, trusses 302 are arranged adjacent to one another in a horizontal position and connected together by expandable connector systems 310. Trusses 302 are raised by wires, and a relative length of the wires is adjusted compared to a horizon such that trusses 302 rotate relative to one another and form truss arch 300. In the arched position, ends of trusses 302 are aligned along an arc. In some embodiments, pivot joints 314 are attached along a top portion of trusses 302, and expansion joints 312 are coupled along a lower portion of trusses 302, to allow an upward curving truss arch to be formed. In some embodiments, expandable connector systems 310 can allow trusses 302 to be aligned along various repeating and non-repeating patterns including arcs, waves, flats, angles, and other orientations, whether vertically, horizontally, positions in-between, or combinations thereof.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. An expandable connector system for use with trusses, the system comprising:
an expansion joint having a first cap, a second cap, a first link, and a second link, the first link coupled to the first cap by a first pin, the second link coupled to the second cap by a second pin, and the first link coupled to the second link by a third pin; and
a pivot joint having a third cap coupled to a fourth cap by a fourth pin, the pivot joint spaced apart from the expansion joint,
wherein a pivot axis extends through the fourth pin, and the pivot joint is configured to allow the first and second caps to rotate about the pivot axis between a collapsed position where the first and second caps engage with one another and the first and second links are in a relaxed-hanging position and an expanded position where the first and second caps are spaced apart from one another and where the first and second links are in a tensioned-supporting position to block further rotation of the first and second caps away from one another.

2. The expandable connector system of claim 1, further comprising a third link and a fourth link positioned on an opposing side of the first and second caps from the first link and the second link, respectively, wherein the third link is coupled to the first cap by the first pin, wherein the fourth link is coupled to the second cap by the second pin, and wherein the third link is coupled to the fourth link by the third pin.

3. The expandable connector system of claim 1, wherein a measurement axis extends through the first pin and the third cap, wherein a further measurement axis extends through the second pin and the fourth cap, wherein the measurement axes are substantially parallel in the collapsed position, and wherein the measurement axes are at an angle relative to one another in the expanded position.

4. The expandable connector system of claim 3, wherein the first link includes a mount hole and a plurality of adjustment holes positioned at different distances from the mount hole, wherein the first pin extends through the mount hole, and wherein the third pin extends through one of the adjustment holes and the second link to adjust a maximum relative angle between the measurement axes at the selection of a user.

5. The expandable connector system of claim 4, wherein the second link includes a mount hole and a plurality of adjustment holes positioned at different distances from the mount hole of the second link, wherein the second pin extends through the mount hole of the second link, and wherein the third pin extends through one of the adjustment holes in the first link and one of the adjustment holes of the second link to adjust the angle between the measurement axes at the selection of a user.

6. The expandable connector system of claim 5, wherein the angle is adjustable from about 6 degrees to about 24 degrees.

7. The expandable connector system of claim 6, wherein a first combination of adjustment holes of the first link and the second link sets the angle at about 6 degrees, wherein a second combination of adjustment holes of the first link and the second link sets the angle at about 8 degrees, wherein a third combination of adjustment holes of the first link and the second link sets the angle at about 10 degrees, wherein a fourth combination of adjustment holes of the first link and the second link sets the angle at about 12 degrees, wherein a fifth combination of adjustment holes of the first link and the second link sets the angle at about 14 degrees, wherein a sixth combination of adjustment holes of the first link and the second link sets the angle at about 16 degrees, wherein a seventh combination of adjustment holes of the first link and the second link sets the angle at about 18 degrees, wherein an eighth combination of adjustment holes of the first link and the second link sets the angle at about 20 degrees, wherein a ninth combination of adjustment holes of the first link and the second link sets the angle at about 22 degrees, and wherein a tenth combination of adjustment holes of the first link and the second link sets the angle at about 24 degrees.

8. A truss arch comprising:
a first truss;
a second truss; and
an expandable connector system connected between the first and second trusses, the expandable connector system comprising:
an expansion joint connected between couplers of the first and second trusses, the expansion joint having a first cap, a second cap, a first link, and a second link, the first link coupled to the first cap by a first pin, the second link coupled to the second cap by a second pin, and the first link coupled to the second link by a third pin; and
a pivot joint connected between couplers of the first and second trusses, the pivot joint having a third cap coupled to a fourth cap by a fourth pin, the pivot joint spaced apart from the expansion joint,
wherein a pivot axis extends through the fourth pin, the pivot joint is configured to allow the first and second trusses to rotate relative to one another about the pivot axis, and the expansion joint is configured to move between a collapsed position where the first and second caps engage with one another and the first and second links are in a relaxed-hanging position and an expanded position where the first and second caps are spaced apart from one another and where the first and second links are in a tensioned-supporting position to block further rotation of the first and second trusses relative to one another.

9. The truss arch of claim 8, further comprising a third link and a fourth link positioned on an opposing side of the first and second caps from the first link and the second link, respectively, wherein the third link is coupled to the first cap by the first pin, wherein the fourth link is coupled to the second cap by the second pin, and wherein the third link is coupled to the fourth link by the third pin.

10. The truss arch of claim 8, wherein a measurement axis extends through the first pin and the third cap, wherein a further measurement axis extends through the second pin and the fourth cap, wherein the measurement axes are substantially parallel in the collapsed position, and wherein the measurement axes are at an angle relative to one another in the expanded position.

11. The truss arch of claim 10, wherein the first link includes a mount hole and a plurality of adjustment holes positioned at different distances from the mount hole, wherein the first pin extends through the mount hole, and wherein the third pin extends through one of the adjustment holes and the second link to adjust a maximum relative angle between the measurement axes at the selection of a user.

12. The truss arch of claim 11, wherein the second link includes a mount hole and a plurality of adjustment holes positioned at different distances from the mount hole of the second link, wherein the second pin extends through the mount hole of the second link, and wherein the third pin extends through one of the adjustment holes in the first link and one of the adjustment holes of the second link to adjust the angle between the measurement axes at the selection of a user.

13. The truss arch of claim 12, wherein the angle is adjustable from about 6 degrees to about 24 degrees.

14. The truss arch of claim 13, wherein a first combination of adjustment holes of the first link and the second link sets the angle at about 6 degrees, wherein a second combination of adjustment holes of the first link and the second link sets the angle at about 8 degrees, wherein a third combination of adjustment holes of the first link and the second link sets the angle at about 10 degrees, wherein a fourth combination of adjustment holes of the first link and the second link sets the angle at about 12 degrees, wherein a fifth combination of adjustment holes of the first link and the second link sets the angle at about 14 degrees, wherein a sixth combination of adjustment holes of the first link and the second link sets the angle at about 16 degrees, wherein a seventh combination of adjustment holes of the first link and the second link sets the angle at about 18 degrees, wherein an eighth combination of adjustment holes of the first link and the second link sets the angle at about 20 degrees, wherein a ninth combination of adjustment holes of the first link and the second link sets the angle at about 22 degrees, and wherein a tenth combination of adjustment holes of the first link and the second link sets the angle at about 24 degrees.

15. The truss arch of claim 8, wherein a coupler of the first truss at least partially extends into the first cap and the first pin extends through the first cap and the received coupler, and wherein a coupler of the second truss at least partially extends into the second cap and the second pin extends through the second cap and the received coupler.

16. The truss arch of claim 15, wherein a coupler of the first truss at least partially extends into the third cap and a fifth pin extends through the third cap and the received coupler, and wherein a coupler of the second truss at least partially extends into the fourth cap and a sixth pin extends through the fourth cap and the received coupler.

17. The truss arch of claim 8, wherein the expansion joint is positioned along a first side of the first and second trusses, and wherein the pivot joint is positioned along a second opposite side of the first and second trusses from the expansion joint.

18. The truss arch of claim 17, wherein the first side is one of an upper, lower, left, or right side, and wherein the second sides is a corresponding opposite lower, upper, right, or left side.
